(19) United States
(12) Patent Application Publication
(10) Pub. No.: US 2020/0209011 A1
(43) Pub. Date: Jul. 2, 2020

(54) VEHICLE SYSTEM, AUTONOMOUS VEHICLE, VEHICLE CONTROL METHOD, AND PROGRAM

(71) Applicant: HONDA MOTOR CO., LTD., Minato-ku, Tokyo (JP)

(72) Inventors: Shun Iwasaki, Wako-shi (JP); Takafumi Hirose, Wako-shi (JP); Nobuyuki Watanabe, Wako-shi (JP); Jun Ito, Wako-shi (JP); Rie Fukushima, Wako-shi (JP); Hisakazu Yamane, Tokyo (JP); Masaaki Onoda, Tokyo (JP)

(21) Appl. No.: 16/622,012

(22) PCT Filed: Jun. 15, 2018
(86) PCT No.: PCT/JP2018/022852

§ 371 Date: Dec. 12, 2019

(30) Foreign Application Priority Data
Jun. 16, 2017 (JP) 2017-118915

(51) Int. Cl. G01C 21/36; G05D 1/02; G01C 21/34; G06Q 50/30

(52) U.S. Cl. CPC G01C 21/3667; G05D 1/0291; G06Q 50/30; G01C 21/3476; G01C 21/3661; G01C 21/3438

(57) ABSTRACT

A vehicle system includes an area indicator that specifies an operation area of an autonomous vehicle, a discriminator that discriminates a user with respect to the autonomous vehicle, and a use permitter that allows a user discriminated to be a user who is able to use the autonomous vehicle by the discriminator to occupy and use at least a portion of the autonomous vehicle.

### TECHNICAL FIELD

The present invention relates to a vehicle system, an autonomous vehicle, a vehicle control method, and a program.

Priority is claimed on Japanese Patent Application No. 2017-118915, filed Jun. 16, 2017, the content of which is incorporated herein by reference.

### BACKGROUND ART

Since the past, an imaging information sharing system including a plurality of vehicles capable of autonomous traveling which transport users or baggage in accordance with vehicle allocation information indicated by a management device has been known (see, for example, Patent Literature 1). In this system, each of the vehicles includes an imaging information acquirer that collects imaging information captured during traveling and standby, and the management device includes an imaging information database that stores imaging information received from each of the vehicles through wireless communication with the vehicle, and an imaging information transmitter that reads out imaging information on a corresponding place from the imaging information database in a case where a request for acquisition of the imaging information is received from a terminal or a vehicle of a user and transmits the read-out information to the terminal or the vehicle of the user who has requested the imaging information.

### CITATION LIST

### Patent Literature

[Patent Literature 1]

Japanese Unexamined Patent Application, First Publication No. 2015-179414

### SUMMARY OF INVENTION

### Technical Problem

However, in the related art, it was not possible to provide the mode of use of vehicles closely related to a district in some cases.

The present invention was contrived in view of such circumstances, and one object thereof is to provide a vehicle system, an autonomous vehicle, a vehicle control method, and a program that make it possible to provide the mode of use of vehicles closely related to a district.

### Solution to Problem

A vehicle system, autonomous vehicle, a vehicle control method, and a program according to this invention have the following configurations adopted therein.

(1) According to an aspect of this invention, there is provided a vehicle system including: an area indicator that specifies an operation area of an autonomous vehicle (332); a discriminator that discriminates a user with respect to the autonomous vehicle (272); and a use permitter that allows a user discriminated to be a user who is able to use the autonomous vehicle by the discriminator to occupy and use at least a portion of the autonomous vehicle.

(2) In the aspect of the above (1), the area indicator indicates routes varying according to time slots to the autonomous vehicle within the operation area.

(3) In the aspect of the above (1) or (2), the vehicle system further includes: a communicator (310) that communicates with a user's terminal device (100); and a route indicator that indicates a route to the autonomous vehicle on the basis of one or both of a prescribed route for circulating inside the operation area along a route determined in advance and an on-demand route based on information received by the communicator.

(4) In the aspect of the above (3), the route indicator compares a degree of priority of the prescribed route with a degree of priority of the on-demand route, and indicates either route to the autonomous vehicle.

(5) In the aspect of the above (4), the route indicator allocates a traveling period for the on-demand route on the basis of a use situation of the autonomous vehicle corresponding to the prescribed route.

(6) In any one aspect of the above (1) to (5), an in-vehicle communicator (220) that communicates with a user's terminal device and transmits information indicating whether the autonomous vehicle is available is mounted in the autonomous vehicle.

(7) In any one aspect of the above (3) to (6), the vehicle system further includes a vehicle allocator that allocates a plurality of the autonomous vehicles in order to circulate inside the operation area.

(8) In any one aspect of the above (1) to (7), the autonomous vehicle further includes: an imaging unit (210, 280) that captures an inside or outside image of the vehicle; an in-vehicle communicator that transmits feature data of an image captured by the imaging unit to a server device; an event determiner (282, 360) that determines an event on the basis of feature data which is at least temporarily stored in the server device; and a provider (250, 270, 282, 284) that provides a notification on the basis of event information determined by the event determiner and user information discriminated by the discriminator.

(9) According to an aspect of this invention, there is provided an autonomous vehicle including: an in-vehicle communicator; an area indicator that specifies an operation area using a signal received in the in-vehicle communicator; and an autonomous controller that generates a prescribed route for circulating within a range of the operation area, wherein the autonomous controller selects an on-demand route instead of the prescribed route on the basis of a use situation of the operation area received by the in-vehicle communicator.

(10) According to an aspect of this invention, there is provide a vehicle control method including causing a computer to: indicate a route to an autonomous vehicle within an operation area; discriminate a user who is able to use the autonomous vehicle; allow a user discriminated to be a user who is able to use the autonomous vehicle to occupy and use at least a portion of the autonomous vehicle; and control the number of autonomous vehicles within the operation area on the basis of an occupation and use state of the at least a portion.

(11) According to an aspect of this invention, there is provide a program causing a computer to: specify an autonomous vehicle within an operation area; indicate a route to the specified autonomous vehicle; discriminate a user who is able to use the autonomous vehicle; allow a user discriminated to be a user who is able to use the autonomous vehicle to start to occupy and use at least a portion of the autonomous vehicle; and continuously monitor an occupation and use state of the at least a portion, and control the number of autonomous vehicles within the operation area on the basis of the occupation and use state.

### Advantageous Effects of Invention

According to (1) to (11), it is possible to provide the mode of use of vehicles closely related to a district.

According to (2), it is possible to travel on more roads within an operation area. Therefore, a user can easily find a vehicle.

According to (3) to (5) or (7), it is possible to travel along an on-demand route while maintaining circulation along a prescribed route. Thereby, it is possible to provide a service adapted for a user's needs.

According to (6) or (8), it is possible to provide effective information to a user.

### BRIEF DESCRIPTION OF DRAWINGS

FIG. 1 is a configuration diagram of a vehicle system of a first embodiment.

FIG. 2 is a configuration diagram of a vehicle of the first embodiment.

FIG. 3 is a configuration diagram of the vehicle of the first embodiment.

FIG. 4 is a diagram showing an example of content of user information.

FIG. 5 is a diagram showing an example of a boarding request screen which is displayed on a display of a terminal device.

FIG. 6 is a diagram showing an example of a boarding request result screen which is displayed on the terminal device.

FIG. 7 is a diagram showing an example of content of route information.

FIG. 8 is a diagram showing a status in which vehicles travel around an operation area.

FIG. 9 is a flow chart showing an example of a flow of processes which are executed by a vehicle management device.

FIG. 10 is a flow chart showing an example of a flow of processes which are executed by a vehicle.

FIG. 11 is a configuration diagram of a vehicle system of a second embodiment.

FIG. 12 is a configuration diagram of a station communication device.

FIG. 13 is a diagram showing a status in which a user U performs a boarding request from the station communication device.

FIG. 14 is a configuration diagram of a vehicle system of a third embodiment.

FIG. 15 is a configuration diagram of a vehicle of the third embodiment.

FIG. 16 is a diagram showing a process of determining an event.

FIG. 17 is a configuration diagram of a vehicle of a fourth embodiment.

### DESCRIPTION OF EMBODIMENTS

Hereinafter, an embodiment of a vehicle system, an autonomous vehicle, a vehicle control method, and a program of the present invention will be described with reference to the accompanying drawings. The vehicle system is a system for assisting a desired user to use a vehicle. This vehicle is, for example, an autonomous vehicle that does not basically require a driving operation. In the following description, an autonomous vehicle is used, but a manual driving vehicle may be used.

### First Embodiment

[Overall Configuration]

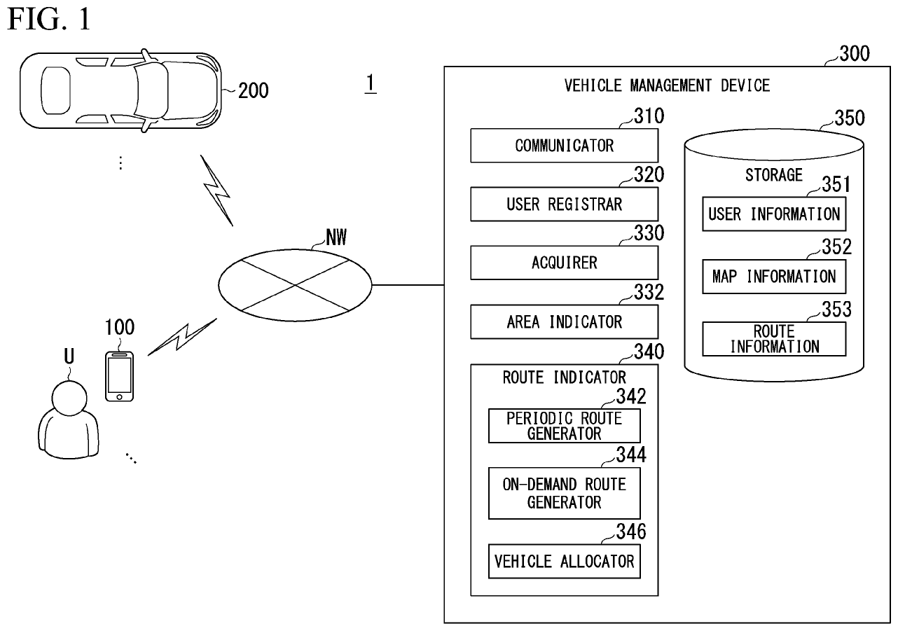

FIG. 1 is a configuration diagram of a vehicle system 1 of a first embodiment. The vehicle system 1 includes one or more terminal devices 100 which are used by one or more users U, one or more vehicles 200, and a vehicle management device 300.

These components can communicate with one another through a network NW. The network NW includes the Internet, a wide area network (WAN), a local area network (LAN), a public line, a provider device, a dedicated channel, a wireless base station, or the like. Meanwhile, the wording “used by users U” may include terminal devices, capable of being used by an unspecified large number of users, such as terminal devices in an Internet cafe being temporarily used by the users U. In addition, the vehicle management device 300 is an example of a “server device.”

[Terminal Device]

The terminal device 100 is, for example, a smartphone, a tablet terminal, a personal computer, or the like. In the terminal device 100, an application program, a browser or the like for using the vehicle system 1 is started up, and a vehicle use service or the like to be described below is supported. In the following description, it is assumed that the terminal device 100 is a smartphone, and that an application program (a vehicle control application) is started up. The vehicle control application communicates the vehicle management device 300 in accordance with the user U's operation, and transmits the user U's request to the vehicle management device 300, or performs a push notification based on information received from the vehicle management device 300.

[Vehicle]

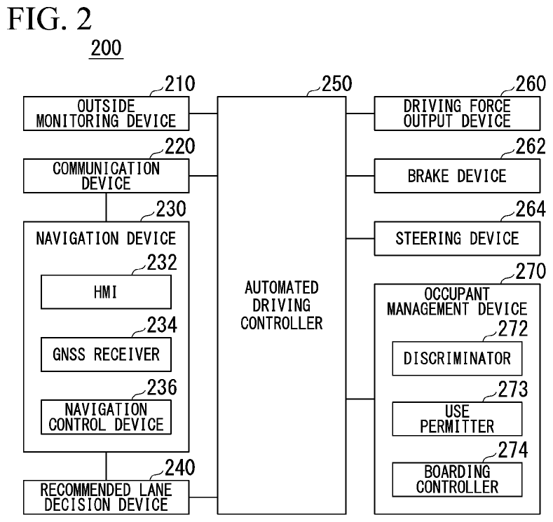

The vehicle 200 is, for example, a vehicle having four or more wheels which are capable of being used by a plurality of users U, and may be vehicles other than a motorcycle. FIG. 2 is a configuration diagram of the vehicle 200 of the first embodiment. The vehicle 200 includes, for example, an outside monitoring device 210, a communication device 220, a navigation device 230, a recommended lane decision device 240, an automated driving controller 250, a driving force output device 260, a brake device 262, a steering device 264, and an occupant management device 270. In addition, the occupant management device 270 includes, for example, a discriminator 272, a use permitter 273, and a boarding controller 274. The automated driving controller 250 and the occupant management device 270 have a processor such as, for example, a CPU that executes a program (software) stored in a storage (not shown) within the vehicle 200. The program may be stored in a storage such as a hard disk drive (HDD) or a flash memory in advance, may be stored in a detachable storage medium such as a DVD or a CD-ROM, or may be installed in the storage by the storage medium being mounted in a drive device (not shown). A portion of the outside monitoring device 210 and an in-vehicle camera 280 to be described later are an example of an “imaging unit.” In addition, the communication device 220 is an example of an “in-vehicle communicator.” In addition, a combination of the automated driving controller 250, the occupant management device 270, an event determination device 282 to be described later, and an information output device 284 is an example of a “provider.”

The outside monitoring device 210 includes, for example, a camera, a radar, a light detection and ranging (LIDAR) sensor, an object recognition device that performs a sensor fusion process on the basis of the outputs thereof, or the like. The outside monitoring device 210 estimates the type of object (particularly, a vehicle, a pedestrian, and a bicycle) present in the vicinity of the vehicle 200, and outputs the estimated type to the automated driving controller 250 together with information on the position or speed.

The communication device 220 is, for example, a wireless communication module for connection to the network NW or directly communication with the terminal device 100, the vehicle management device 300, another vehicle, or the like. The communication device 220 performs wireless communication on the basis of Wi-Fi, dedicated short range communications (DSRC), Bluetooth (registered trademark), or another communication standard. As the communication device 220, a plurality of devices for its use may be prepared. For example, the communication device 220 communicates with the terminal device 100, and transmits information indicating whether the vehicle 200 is available.

The navigation device 230 includes, for example, a human machine interface (HMI) 232, a global navigation satellite system (GNSS) receiver 234, and a navigation control device 236. The HMI 232 includes, for example, a touch panel-type display device, a speaker, a microphone, or the like. The GNSS receiver 234 measures its position (the position of the vehicle 200) on the basis of radio waves arriving from a GNSS satellite (for example, a GPS satellite). The navigation control device 236 includes, for example, a central processing unit (CPU) or various storage devices, and controls the entirety of the navigation device 230. Map information (a navigation map) is stored in the storage device. The navigation map is a map in which roads are represented using nodes and links.

The navigation control device 236 refers to the navigation map to decide a route to a destination designated using the HMI 232 from the position of the vehicle 200 measured by the GNSS receiver 234. In addition, the navigation control device 236 may transmit the position of the vehicle 200 and the destination to a navigation server (not shown) using the communication device 220, and acquire a route sent back from the navigation server.

In addition, in the case of the first embodiment, a route may be designated by the vehicle management device 300. The route in this case includes one or both of a prescribed route for circulating inside an operation area along a route determined in advance and an on-demand route including a route to the terminal device 100 possessed by a user who boards the vehicle 200 and a route to a destination set by the user on board the vehicle. The wording “inside an operation area” may be a range for each municipality, a specific district within a municipality, or a district straddling a plurality of municipalities. Circulation includes, for example, a case of revolving around the same route or a case of revolving around a different route in a time slot. In addition, circulation also includes, for example, going and coming to city A and city B. Hereinafter, an example of the prescribed route will be described using a periodic route for traveling on a route determined periodically. The on-demand route is a route which is generated in the vehicle management device 300 in a case where there is a boarding request from the terminal device 100. In addition, information of arrival target times and points at which a vehicle stops in order to allow a user to board or alight from the vehicle may be associated with each route. In addition, information such as passing through a destination point or a route in a certain time range or departure from and arrival at a certain point in a certain time range may be associated with each route.

The navigation control device 236 outputs information of a route decided using any of the foregoing methods to the recommended lane decision device 240.

The recommended lane decision device 240 includes, for example, a map positioning unit (MPU) and various storage devices. High-accuracy map information which is more detailed than the navigation map is stored in the storage device. The high-accuracy map information includes, for example, information such as a road width or gradient for each lane, curvature, or the position of a signal. The recommended lane decision device 240 decides a preferred recommended lane in order to travel along a route which is input from the navigation device 230, and outputs the decided recommended lane to the automated driving controller 250.

The automated driving controller 250 includes one or more processors such as a CPU or a micro processing unit (MPU) and various storage devices. The automated driving controller 250 causes the vehicle 200 to travel autonomously while avoiding contact with an object of which the position or speed is input from the outside monitoring device 210 with travel in the recommended lane decided by the recommended lane decision device 240 as a principle. The automated driving controller 250 sequentially executes, for example, various types of control. Examples of the control include constant-speed traveling control for traveling in the same traveling lane at a constant speed, following traveling control for following a preceding vehicle, lane change control, merging control, divergence control, emergency stop control, tollbooth control for passing a tollbooth, handover control for terminating autonomous driving and switching to manual driving, and the like. In addition, during execution of the above control, behavior for avoidance may be planned on the basis of the surrounding situation (such as the presence of a nearby vehicle or pedestrian or lane narrowing caused by road construction) of the vehicle 200.

The automated driving controller 250 generates a target trajectory along which the vehicle 200 will travel in the future. The target trajectory includes, for example, a speed element. For example, the target trajectory is represented as points (trajectory points), lined up in order, to be reached by a host vehicle M. A trajectory point is a point to be reached by the host vehicle M for each predetermined traveling distance, and aside from this, target speed and target acceleration for each predetermined sampling time (for example, approximately several tenths of a [sec]) are generated as a portion of the target trajectory. In addition, the trajectory point may be a position, for each predetermined sampling time, to be reached by the host vehicle M at the sampling time. In this case, information of the target speed or the target acceleration is represented by an interval between trajectory points.

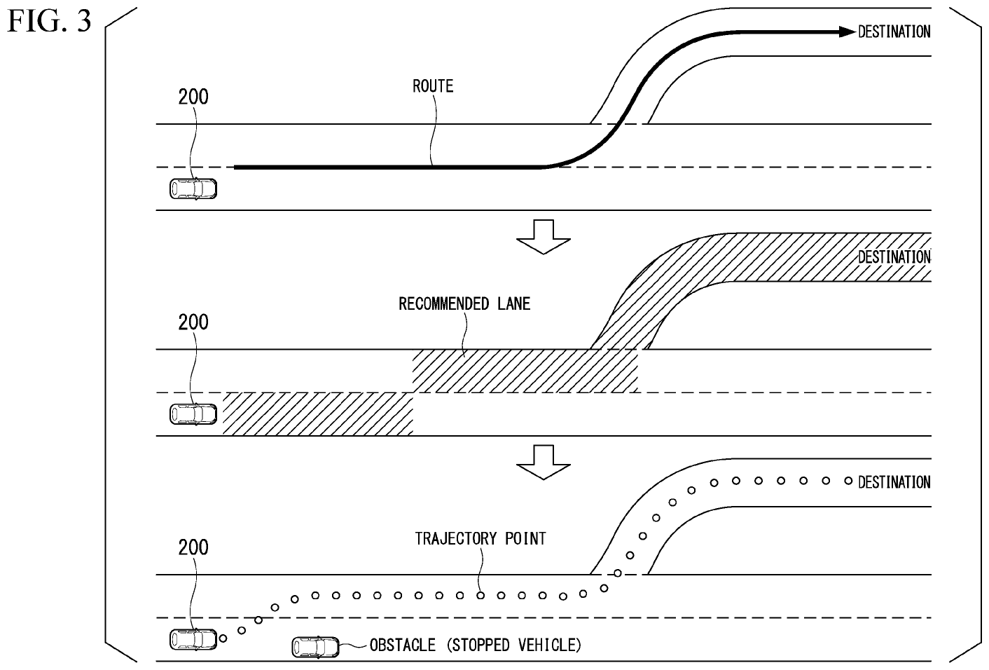

FIG. 3 is a diagram showing a process stage of autonomous driving. First, as shown in the upper diagram, a route is decided by the navigation device 230. This route is, for example, a rough route in which lanes are not distinguished from each other. Next, as shown in the middle diagram, the recommended lane decision device 240 decides a recommended lane in which a vehicle has a tendency to travel along a route. As shown in the lower diagram, the automated driving controller 250 generates trajectory points for traveling along a recommended lane if possible while avoiding obstacles or the like, and controls some or all of the driving force output device 260, the brake device 262, and the steering device 264 to travel along the trajectory points (and an associated speed profile). Meanwhile, such sharing of roles is merely an example, and, for example, the automated driving controller 250 may centrally perform a process. In addition, the automated driving controller 250 may perform various types of control relating to the above-described autonomous driving through control performed by the occupant management device 270.

The driving force output device 260 outputs a traveling drive force (torque) for a vehicle to travel to a driving wheel. The driving force output device 260 includes, for example, a combination of an internal-combustion engine, an electric motor, a transmission or the like, and a power ECU that controls these components. The power ECU controls the above components in accordance with information which is input from the automated driving controller 250 or information which is input from a driving operator (not shown).

The brake device 262 includes, for example, a brake caliper, a cylinder that transfers hydraulic pressure to the brake caliper, an electric motor that generates hydraulic pressure in the cylinder, and a brake ECU. The brake ECU controls the electric motor in accordance with the information which is input from the automated driving controller 250 or the information which is input from the driving operator, and causes a brake torque according to a braking operation to be output to each wheel. The brake device 262 may include a mechanism that transfers hydraulic pressure generated by the operation of a brake pedal included in the driving operator through a master cylinder to the cylinder as a backup. Meanwhile, the brake device 262 is not limited to the above-described configuration, and may be an electronic control type hydraulic pressure brake device that controls an actuator in accordance with the information which is input from the automated driving controller 250 and transfers hydraulic pressure of the master cylinder to the cylinder.

The steering device 264 includes, for example, a steering ECU and an electric motor. The electric motor changes the direction of a turning wheel, for example, by causing a force to act on a rack and pinion mechanism. The steering ECU drives the electric motor in accordance with the information which is input from the automated driving controller 250 or the information which is input from the driving operator, and changes the direction of the turning wheel.

The occupant management device 270 manages a user's boarding and alighting from the vehicle 200. In addition, the occupant management device 270 manages the number of occupants or the seating capacity of the vehicle 200. The discriminator 272 discriminates a user with respect to the vehicle 200. The use permitter 273 performs control for allowing a user discriminated to be a user who can use the vehicle 200 by the discriminator 272 to board the vehicle 200. Specifically, the use permitter 273 allows the user discriminated to be a user who can use the vehicle 200 by the discriminator 272 to occupy and use at least a portion of the vehicle 200. The wording “allowing occupying and using at least a portion” refers to, for example, occupying and using at least one of a plurality of seats in the vehicle interior. In addition, the boarding controller 274 performs control for allowing the user permitted to occupy and use at least a portion of the vehicle 200 by the use permitter 273 to board or alight from the vehicle. The details of functions of the discriminator 272, the use permitter 273, and the boarding controller 274 will be described later.

[Vehicle Management Device 300]

Referring back to FIG. 1, the vehicle management device 300 includes, for example, a communicator 310, a user registrar 320, an acquirer 330, an area indicator 332, a route indicator 340, and a storage 350.

The user registrar 320, the acquirer 330, the area indicator 332, and the route indicator 340 are realized by a processor such as, for example, a CPU executing a program (software) stored in the storage 350. In addition, some or all of these functional units may be realized by hardware such as an LSI, an ASIC, or an FPGA, or may be realized by software and hardware in cooperation. The program may be stored in the storage 350 such as a hard disk drive (HDD) or a flash memory in advance, may be stored in a detachable storage medium such as a DVD or a CD-ROM, or may be installed in the storage 350 by the storage medium being mounted in a drive device (not shown).

The communicator 310 is, for example, a network card for connection to the network NW. The communicator 310 communicates with the terminal device 100 or the vehicle 200 through the network NW.

The user registrar 320 registers a user who uses a vehicle use service provided by the vehicle system 1. The user registrar 320 registers, for example, information relating to a day of the week, a time slot, and a use section for using the vehicle 200 which are input by the terminal device 100. Various types of information registered by the user registrar 320 are stored in the storage 350 as user information 351.

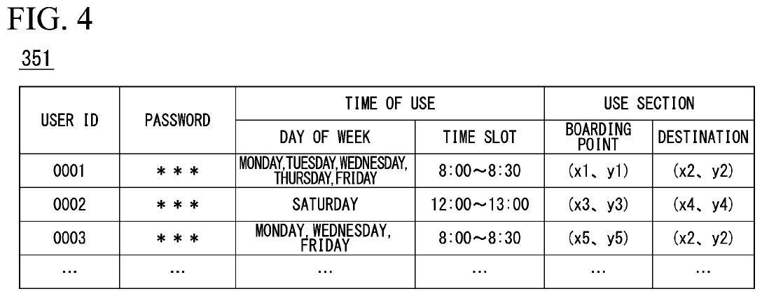

FIG. 4 is a diagram showing an example of content of the user information 351. In the user information 351, a password that is authentication information used in the authentication of a user, and a time of use and a use section of the vehicle 200 are associated with a user ID that is identification information of the user. The time of use is, for example, a day of the week and a time slot. The use section is, for example, a section from a boarding point to a destination. The boarding point and the destination are represented by, for example, map coordinates. In addition, the user information 351 may contain information of a contact address (a notification destination) in a case where abnormality occurs in the user.

In addition, after the completion of registration of the user information 351, the user registrar 320 transmits information indicating the completion of registration to the terminal device 100. The information indicating the completion of registration contains, for example, information relating to a user ID or a password. In addition, the information indicating the completion of registration may contain a code such as a bar code or a QR code (registered trademark) for permitting boarding the vehicle 200. Information such as a user ID or a user's destination, for example, is encoded in the code. In addition, the user registrar 320 may transmit the user information 351 to the vehicle 200.

The acquirer 330 acquires a boarding request from the terminal device 100 possessed by a user who desires to board the vehicle 200.

The area indicator 332 specifies an operation area of the vehicle 200. In addition, the area indicator 332 indicates routes varying according to time slots to the vehicle 200 within the operation area. The details of a function of the area indicator 332 will be described later.

The route indicator 340 includes, for example, a periodic route generator 342, an on-demand route generator 344, and a vehicle allocator 346. The periodic route generator 342 generates a periodic route in which the vehicle 200 travels on the basis of the user information 351 and map information 352. The on-demand route generator 344 generates an on-demand route including a route to the position of a user who will board a vehicle and a route to a destination after the user is taken on board the vehicle on the basis of the boarding request obtained by the acquirer 330. The vehicle allocator 346 allocates a plurality of vehicles 200 for traveling inside the operation area. The details of functions of the periodic route generator 342, the on-demand route generator 344, and the vehicle allocator 346 will be described later.

The storage 350 is realized by an HDD, a flash memory, a random access memory (RAM), a read only memory (ROM), or the like. The storage 350 has, for example, the user information 351, the map information 352, route information 353, and other information stored therein.

The map information 352 contains, for example, road information, traffic regulation information, address information (an address or a postal code), facility information, telephone number information, or the like. The road information contains information indicating the type of road such as an expressway, a toll road, a national road, or a prefectural road, or information such as the number of lanes of a road, an area of an emergency parking area, the width of each lane, the gradient of a road, the position (three-dimensional coordinates including longitude, latitude, and altitude) of a road, the curvature of a lane curve, the position of a merging and divergence point of a lane, or a mark provided on a road. The map information 352 may be updated at any time by accessing another device using the communication device 220.

The route information 353 is information relating to a route allocated for each of the vehicles 200. The route information 353 contains one or both of the periodic route or the on-demand route. The details of the route information 353 will be described later.

[Vehicle Use Service Provided by Vehicle System 1]

Next, an example of a vehicle use service provided by the vehicle system 1 of the first embodiment will be described. First, a user accesses the vehicle management device 300 using the terminal device 100, and performs user registration for receiving a vehicle use service provided by the vehicle system 1 through the user registrar 320.

The area indicator 332 ascertains which user desires to board a vehicle in which time slot and in which district on the basis of the user information 351 registered in advance, and specifies a district including a boarding point as an operation area on the basis of the ascertained information. The periodic route generator 342 generates the number of vehicles 200 in circulation and a route for each of the vehicles 200 with respect to the operation area specified by the area indicator 332. In this case, the periodic route generator 342 generates routes varying according to time slots in which a vehicle 200 in circulation in the operation area travels within the operation area. In addition, in a case where a plurality of vehicles are in circulation in the operation area, the periodic route generator 342 may generate a route on which each of the vehicles 200 travels along a different route.

The periodic route generator 342 transmits the generated periodic route to the vehicle 200. The vehicle 200 travels on the basis of the periodic route generated by the periodic route generator 342. In this manner, the number of vehicles 200 and a route are decided in accordance with the time slot of a user obtained from the user information 351, and thus it is possible to achieve both suppression of traffic congestion and an improvement in the operation rate of vehicles. In addition, the vehicles 200 are allowed to travel different routes for each time slot or for each of the vehicles 200, and thus it is possible to travel on more roads within the operation area. Therefore, a user can easily find the vehicle 200. In addition, the vehicle 200 is allowed to travel on a periodic route. Thereby, even in a case where a user does not transmit a boarding request immediately before the user boards the vehicle 200, the user can quickly find and use the vehicle 200, and thus it is possible to improve the user's convenience.

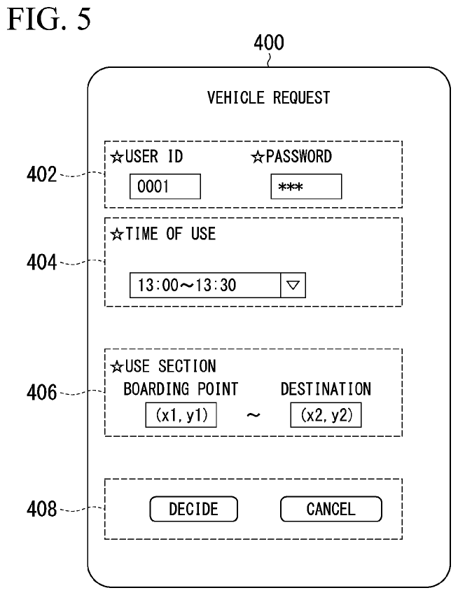

In addition, in a case where the user desires to board the vehicle 200, the user may transmit a boarding request from the terminal device 100. FIG. 5 is a diagram showing an example of a boarding request screen 400 which is displayed on a display of the terminal device 100. The boarding request screen 400 shows a user information input area 402, a use time slot input area 404 for inputting a use time slot, a boarding/alighting position input area 406 for inputting information of a use section (a boarding position and a destination), and a decision operation area 408 for deciding or canceling set content.

The user inputs user information registered in advance from the boarding request screen 400, and inputs information relating to a time of use and a use section, to select a decision button of the decision operation area 408. The terminal device 100 transmits the boarding request to the vehicle management device 300 through the network NW.

In a case where the boarding request is received from the terminal device 100 through the communicator 310, the on-demand route generator 344 searches for a vehicle traveling near the terminal device 100 at this point in time, that is a vehicle 200 capable of being used by the user, and generates an on-demand route for the vehicle 200 obtained in the search result. A position near the terminal device 100 may be, for example, a position within a predetermined range of the terminal device 100, may be a position relatively closer to the terminal device 100 than to another vehicle, or may be both positions. In addition, the wording “capable of being used” refers to, for example, the number of occupants in the vehicle 200 being less than a predetermined seating capacity.

The route indicator 340 indicates a route to the vehicle 200 on the basis of one or both of the periodic route generated by the periodic route generator 342 and the on-demand route generated on the basis of the boarding request by the on-demand route generator 344. For example, the route indicator 340 compares the degree of priority of the periodic route generated by the periodic route generator 342 with the degree of priority of the on-demand route generated by the on-demand route generator 344, and indicates a route having a high degree of priority to the vehicle 200. The degree of priority of each route may be set in advance on the vehicle management device 300 side, or may be set by an indication from the terminal device 100. In addition, the degree of priority of each route may be set on the basis of the use situation of the vehicle 200 that travels on the periodic route or the on-demand route.

In addition, the on-demand route generator 344 may allocate a traveling period for the on-demand route on the basis of the use situation of the vehicle 200 corresponding to the periodic route. For example, the on-demand route generator 344 determines whether there is spare time in the use situation of the vehicle 200 on the periodic route. The wording “there is spare time” refers to, for example, there not being a user's use schedule for a predetermined time or more. The predetermined time is, for example, a time including a predetermined margin in a time predicted not to influence an operation of a scheduled periodic route. The on-demand route generator 344 transmits the generated on-demand route to the vehicle 200. The vehicle 200 travels on the basis of the on-demand route in spare time of the use situation.

For example, in a case where the periodic route and the on-demand route are generated, the vehicle allocator 346 may indicate routes to at least a given number of vehicles 200 out of a plurality of vehicles 200 determined in advance by adjusting the number of vehicles so as to travel on the periodic route. Thereby, it is possible to travel on the on-demand route while maintaining circulation on the periodic route. Therefore, it is possible to provide a vehicle use service adapted for a user's needs.

In addition, in a case where the boarding request concentrates on a specific point, and vehicles concentrate on a specific route, the vehicle allocator 346 may shift a time to before or after the time of use of the on-demand route in the boarding request, or disperse routes. Thereby, it is possible to optimize a schedule of vehicle allocation, and to make traffic flow within an operation area efficient.

In addition, the vehicle allocator 346 may attempt to allocate the number of available vehicles with respect to demand within the operation area, and output a vehicle allocation request to a vehicle use service of another area or a third party in a case where the allocation is impossible. The vehicle allocator 346 sets a vehicle allocated by the acceptance of the vehicle allocation request as a vehicle within the operation area, and indicates a route to the set vehicle.

In addition, the route indicator 340 transmits a boarding request result to the terminal device 100. The terminal device 100 displays the boarding request result received from the vehicle management device 300.

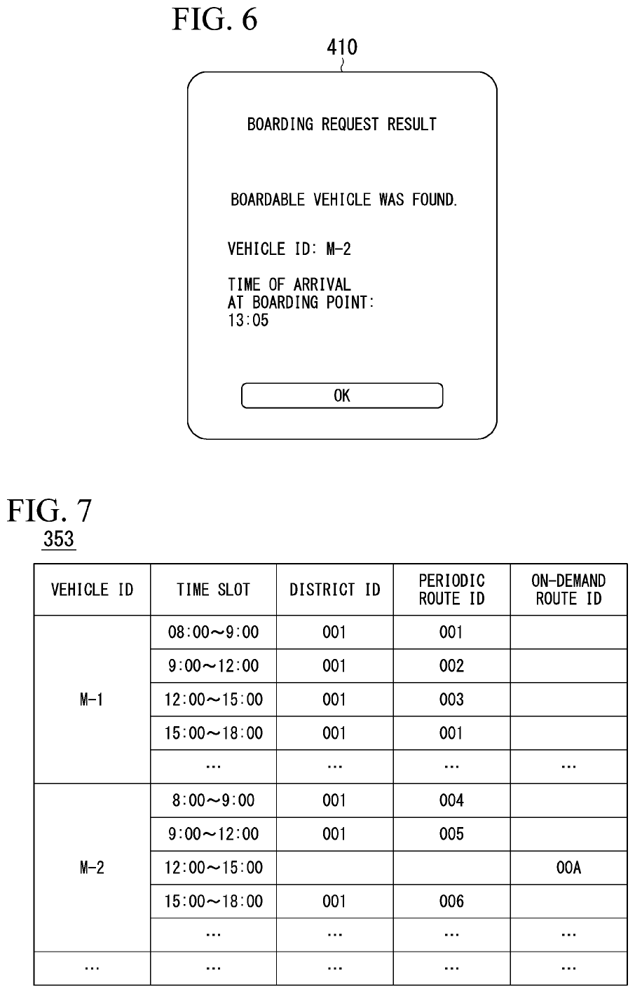

FIG. 6 is a diagram showing an example of a boarding request result screen 410 which is displayed on the terminal device 100. The boarding request result screen 410 shows information indicating whether an available vehicle is present, identification information (a vehicle ID) of an available vehicle 200, and an estimated time of arrival of the vehicle 200 at a boarding point, as the boarding request result. A user can easily ascertain whether or not to board a vehicle at the request of the user with reference to the boarding request result screen 410.

In addition, the route indicator 340 stores the generated route as the route information 353 in the storage 350. FIG. 7 is a diagram showing an example of content of the route information 353. In the route information 353, the vehicle ID is associated with a time slot, a district ID that is district information on circulation, a periodic route ID that is identification information on a periodic route, and an on-demand route ID that is identification information on an on-demand route. A route associated with each ID is set in the periodic route ID and the on-demand route ID. The vehicle management device 300 can centrally manage the allocation of the vehicles 200 to each district of the vehicles 200 by managing the route information 353.

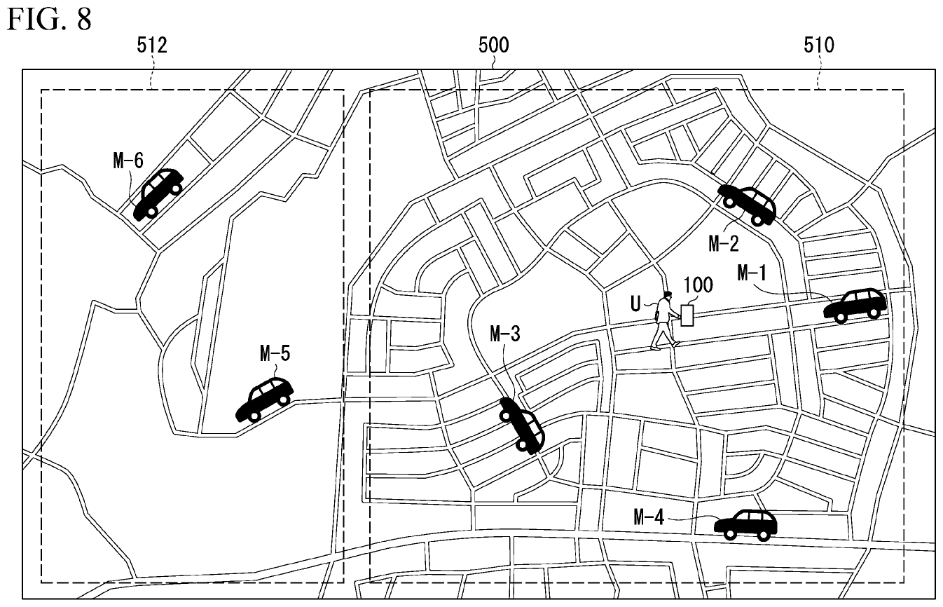

FIG. 8 is a diagram showing a status in which the vehicles 200 circulates in an operation area. In the example of FIG. 8, it is assumed that two areas 510 and 512 are allocated on a map 500. In addition, it is assumed that four vehicles M-1 to M-4 travel on a periodic route in the area 510, and that two vehicles M-5 and M-6 travel on a periodic route in the area 512.

Here, the vehicle M-1 detects a user U who desires to board a vehicle using the outside monitoring device 210 during periodic traveling. For example, the occupant management device 270 learns the feature of the user U who desires to board a vehicle from an image captured by the camera of the outside monitoring device 210 using machine learning such as deep learning, and detects the user U who desires to board a vehicle from the captured image. The machine learning uses an algorithm such as, for example, a convolutional neural network (CNN) or adaptive boosting (AdaBoost).

In addition, the occupant management device 270 may estimate a person's shape using luminance information or color information (R, G, B) on each pixel of an image captured by the camera of the outside monitoring device 210, and determine that the user U desires to board a vehicle in a case where a shape in which the estimated person raises his or her hand is shown.

The occupant management device 270 controls the automated driving controller 250 so that a vehicle stops at a point where the user U who desires to board a vehicle is standing. Next, the discriminator 272 determines whether the user U can board the vehicle M-1.

For example, the discriminator 272 may perform authentication by accepting speech of a user ID and a password based on a voice from outside of a vehicle during boarding, or may perform authentication by inputting the user ID and the password to a terminal provided on the surface of the vehicle or inside the vehicle. The discriminator 272 refers to the user information 351 received from the vehicle management device 300 on the basis of the input user ID and password, to determine that the user can use a vehicle when it matches the user ID and the password included in the user information 351, and determine that the user cannot board the vehicle when it does not match.

In addition, the discriminator 272 may read a code such as a bar code or a QR code drawn on an image displayed on the display of the terminal device 100 using a code reader (not shown) included in the vehicle 200, and determine that the user U's boarding is possible in a case where the read code is a code for permitting boarding. In this case, the discriminator 272 reads information encoded in a code held up to the code reader, decodes the read information, and acquires electronic information. The discriminator 272 determines that the user U's boarding is possible in a case where the information read by the code reader and the information received from the vehicle management device 300 in advance match, and determines that the user U's boarding is impossible in a case where they do not match. Meanwhile, the discriminator 272 may transmit the acquired information to the vehicle management device 300, and acquire a result of determination of whether the user U can board a vehicle from the vehicle management device 300.

In addition, the discriminator 272 may read a user ID and a password from the terminal device 100 using the terminal device 100 and wireless communication such as dedicated short range communications (DSRC) or Felica (registered trademark), and refer to the user information 351, to determine that the user can use a vehicle when they match the user ID and the password included in the user information 351, and determine that the user cannot board the vehicle when they do not match. Meanwhile, the discriminator 272 may transmit the user ID and the password acquired from the terminal device 100 using wireless communication to the vehicle management device 300, and acquire a result of determination of whether the user U can board a vehicle that is a result of performing collation of a face image in the vehicle management device 300 from the vehicle management device 300.

In a case where it is determined that the user U is a user who can use a vehicle, the boarding controller 274 allows the user U to board a vehicle and travel toward a destination included in the user information 351, and controls the automated driving controller 250 so as to allow the user U to alight from the vehicle by stopping at the destination.

In addition, the boarding controller 274 performs a fare adjustment process according to a traveling distance or a traveling time of the user U who alights from a vehicle. The fare adjustment process may be performed by a fare adjustment machine (not shown) included in the vehicle 200, or may be performed by credit card payment or the like.

In addition, the boarding controller 274 allows the user U to alight from a vehicle, and then causes the vehicle 200 to continue to travel by returning the vehicle to a periodic route. In addition, for example, in a case where a group of users are allowed to alight from a plurality of vehicles 200 at the same point, the boarding controller 274 causes the vehicles to move toward routes dispersed from this point or respective different periodic routes and continue to travel.

In addition, in a case where it is determined that the user U is a user who cannot board a vehicle, the discriminator 272 outputs information indicating that the user's boarding is impossible to the user U, and continues traveling on a periodic route. Thereby, since only users managed by the user information 351 are allowed to board a vehicle, these users can board the vehicle with ease even in the case of sharing a ride with others, and thus it is possible to provide a user with an environment that is easy to use.

In addition, the discriminator 272 may output information for allowing the user U determined to be a user who cannot board a vehicle to perform authentication through a separate authentication system or to perform user registration. In a case where it is determined that the user can use a vehicle through the separate authentication system, or a case where user registration is completed, the boarding controller 274 controls the automated driving controller 250 so that the user U is allowed to board a vehicle and the vehicle 200 is caused to travel to a destination.

In addition, in a case where it is determined that the user U is a user who cannot board a vehicle, the discriminator 272 may output information of whether to board a vehicle with an extra fee instead of outputting the information indicating that the user's boarding is impossible to the user U. In a case where the information indicating boarding a vehicle with an extra fee is accepted from the user U, the boarding controller 274 controls the automated driving controller 250 so that the user U are allowed to board a vehicle and the vehicle 200 is caused to travel to a destination. In addition, in a case where the information of whether to board a vehicle with an extra fee is output, the discriminator 272 may add another user not boarding a vehicle to a condition. Thereby, even a user who is not registered with the user information 351 can board the vehicle 200. In addition, it is possible to effectively utilize the vehicle 200 which is boarded by nobody.

[Process Flow]

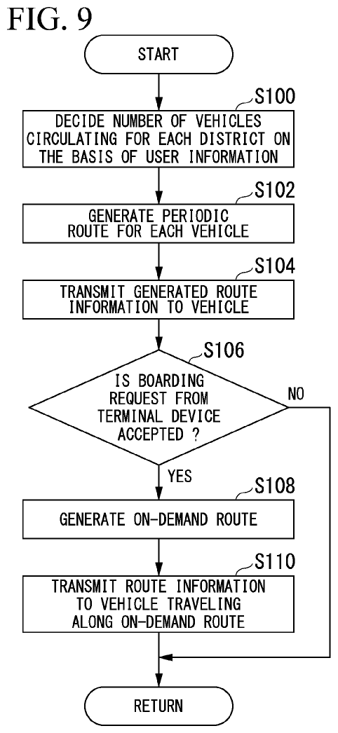

FIG. 9 is a flow chart showing an example of a flow of processes which are executed by the vehicle management device 300. First, the route indicator 340 decides the number vehicles for each district (for example, an operation area) on the basis of the user information 351 (step S100). Next, the periodic route generator 342 decides a periodic route of each vehicle on the basis of the map information 352 (step S102). Next, the periodic route generator 342 transmits the generated periodic route to the vehicle 200 (step S104).

Next, the route indicator 340 determines whether the boarding request has been accepted from the terminal device 100 (step S106). In a case where it is determined that the boarding request has been accepted, the on-demand route generator 344 generates an on-demand route with respect to the accepted boarding request (step S108), and transmits the generated route information to the vehicle 200 that travels along the on-demand route (step S110). Thereby, the process of the present flow chart is terminated. In this manner, the vehicle management device 300 specifies the vehicle 200 within the operation area, indicates a route to the specified vehicle 200, discriminates a user who can use the vehicle, and allows the user who can use the vehicle to start to occupy and use at least a portion of the vehicle 200. In addition, the vehicle management device 300 repeatedly executes the flow chart shown in FIG. 9 at a predetermined timing, to thereby continuously monitor the occupation and use state of at least a portion of the vehicle 200 and control the number of autonomous vehicles within the operation area on the basis of the occupation and use state.

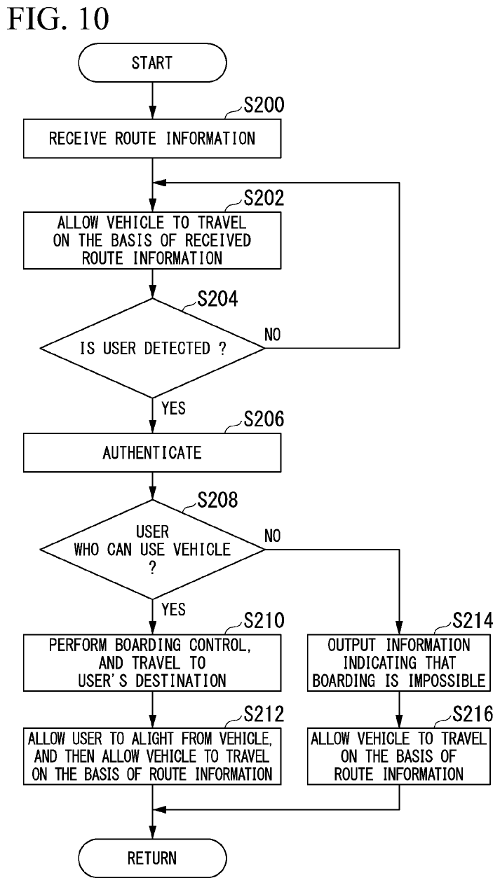

FIG. 10 is a flow chart showing an example of a flow of processes which are executed by the vehicle 200. First, in a case where the route information is acquired by the vehicle management device 300 (step S200), the occupant management device 270 controls the automated driving controller 250 so as to travel on the basis of the route information (step S202). The route information may be a periodic route or may be an on-demand route.

Next, the outside monitoring device 210 determines whether a user has been detected (step S204). In a case where it is determined that the user has been detected, the discriminator 272 performs an authentication process (step S206), and determines whether the user can use the vehicle (step S208). In a case where it is determined that the user can use the vehicle, the boarding controller 274 performs control of the user's boarding, and controls the automated driving controller 250 so that the vehicle 200 allows the user to board the vehicle and then travels to a destination (step S210). Next, the boarding controller 274 allows the user to alight from the destination, and then controls the automated driving controller 250 so that the vehicle 200 travels on the basis of the route information (step S212).

In addition, in a case where it is determined that the user is not a user who can use a vehicle, the discriminator 272 outputs information indicating that boarding is impossible (step S214), and controls the automated driving controller 250 so that the vehicle 200 travels on the basis of the route information (step S216). Thereby, the process of the present flow chart is terminated. Meanwhile, the processes of step S202 and S204, in a case where traveling along a route of the route information is completed in a state where a user is not detected, the process of the present flow chart is terminated. In addition, after the processes of step S212 and step S216 are terminated, a process such as returning to the process of step S204 may be performed.

As described above, according to the vehicle system 1 of the first embodiment, it is possible to provide the mode of use of a vehicle closely related to a district. For example, according to the vehicle system 1 of the first embodiment, the number vehicles traveling in an operation area or a traveling route is decided on the basis of the user information 351 registered in advance. Therefore, even in a case where a user does not perform a boarding request immediately before, it is possible to easily find and board an available vehicle 200. Thereby, it is possible to improve a user's convenience. For example, the vehicle system 1 of the first embodiment can also use, for example, attending school in the morning and evening, the elderly's shopping or ambulatory in the daytime, and a transportation service such as learning in the night.

### Second Embodiment

Next, a second embodiment will be described. In the second embodiment, a periodic route on which the vehicle 200 is in circulation in an operation area is provided with a station at which the vehicle 200 stops, a communication device is installed at the station, and an on-demand route is generated by accepting a boarding request from the installed communication device.

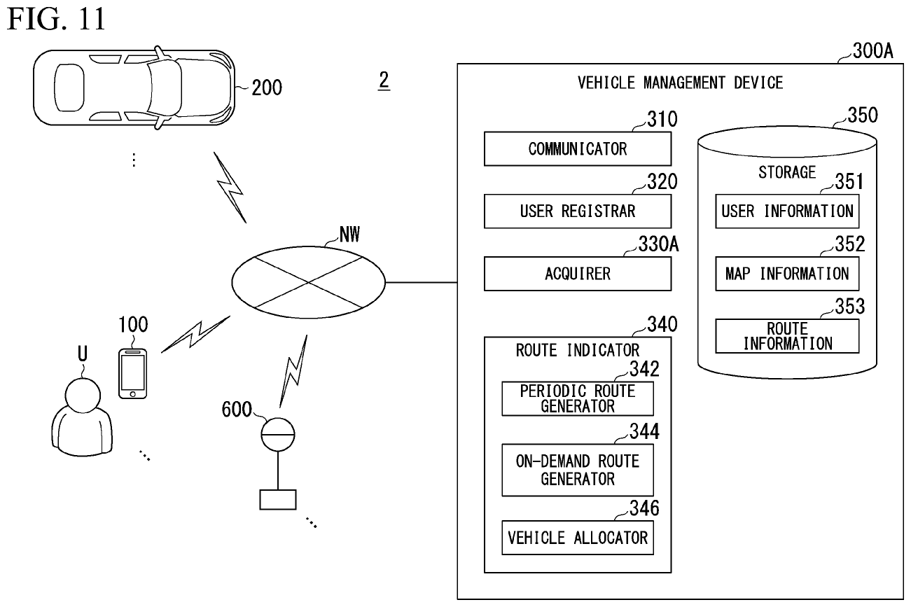

FIG. 11 is a configuration diagram of a vehicle system 2 of the second embodiment. In the vehicle system 2, a station communication device 600 is included, and an acquirer 330A is included in a vehicle management device 300A. Functions of other components are the same as those in the first embodiment. Therefore, hereinafter, in the vehicle system 2, a description will be mainly given with a focus on differences from the vehicle system 1 of the first embodiment.

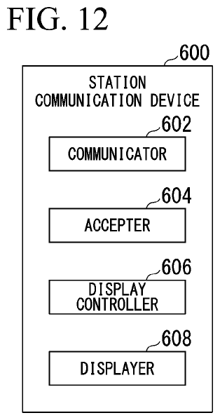

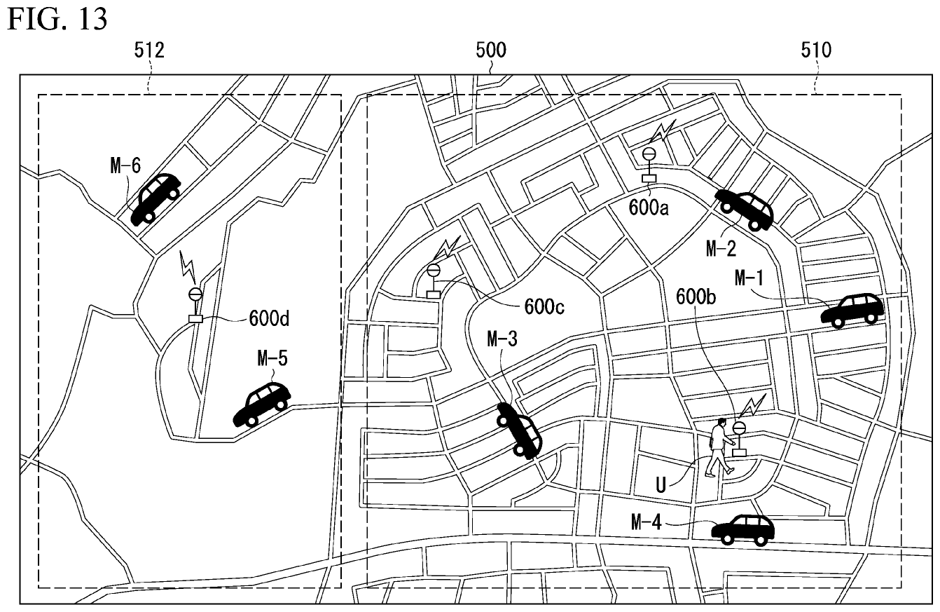

The station communication device 600 is installed at a predetermined point of an operation area. FIG. 12 is a configuration diagram of the station communication device 600. The station communication device 600 includes, for example, a communicator 602, an accepter 604, a display controller 606, and a display 608.

The communicator 602 communicates with the vehicle management device 300A through the network NW. The communicator 602 is a communication interface such as, for example, a wireless communication module. For example, the communicator 602 transmits a boarding request accepted by the accepter 604 to the vehicle management device 300A. In addition, the communicator 602 receives a result of the boarding request transmitted by the vehicle management device 300A. The result of the boarding request contains information indicating whether an available vehicle is present, a vehicle ID, and an estimated time of arrival.

The accepter 604 accepts input of a boarding request from a user. The display controller 606 controls the display 608 so as to display an acceptance screen for the boarding request. In addition, the display controller 606 controls the display 608 so as to display the result of the boarding request transmitted by the vehicle management device 300A.

The display 608 is a liquid crystal display (LCD), an organic electro luminescence (EL) display device, or the like. The display 608 displays, for example, an acceptance screen for the boarding request and a result screen for the boarding request. In addition, the display 608 and the accepter 604 may be a touch panel-type display device formed integrally.

FIG. 13 is a diagram showing a status in which a user U performs a boarding request from the station communication device 600. In the example of FIG. 13, it is assumed that three station communication devices 600a to 600c are installed in an area 510, and that one the station communication device 600d is installed in an area 512. The user U performs a boarding request from a boarding request screen displayed on the display 608 of the station communication device 600b. The boarding request screen is the same screen as the boarding request screen shown in FIG. 5, but the position of the station communication device 600b is set in advance at a boarding point in a use section.

In a case where input of the boarding request is performed, the communicator 602 transmits the boarding request to the vehicle management device 300A. The acquirer 330A acquires request information transmitted from the station communication device 600. The on-demand route generator 344 of the route indicator 340 decides a vehicle traveling nearest the station communication device 600b at this point in time among the vehicles M-1 to M-4 periodically traveling in the area 510, that is, a vehicle that can be used by a user.

In the example of FIG. 13, the vehicle M-4 is assumed to be a vehicle corresponding to the above condition. The on-demand route generator 344 transmits information relating to the generated on-demand route to the vehicle M-4, and transmits a boarding request result to the station communication device 600b. The display controller 606 controls the display 608 so as to display the boarding request result screen 410 as shown in FIG. 6.

As described above, according to the second embodiment, in addition to the exhibition of the same effect as that in the first embodiment, it is possible to perform a boarding request from the station communication device 600b even in a case where a user does not have the terminal device 100. Thereby, it is possible to further improve a user's convenience.

### Third Embodiment

Next, a third embodiment will be described. In the third embodiment, in a case where there is no occupant in the vehicle 200 that periodically travels around an operation area or a case where a user occupying at least a portion of the vehicle 200 has time to spare, a notification service in a monitoring service of a district where the vehicle circulates is provided. The notification service in the monitoring service is, for example, a service for outputting information to the outside and riding a person to a predetermined place in a case where the vehicle 200 monitors the outside world or the inside of the vehicle during traveling and finds the person or the like who is estimated to be sick or injured or estimated to be abnormal. In addition, the monitoring service may be a service for outputting information to the outside in a case where a suspicious person, a lost child, or the like is detected. In the monitoring service, it is preferable to monitor the entirety of an operation area as much as possible, and thus a plurality of vehicles 200 are made travel round through different routes and monitored for each fixed period. Further, in a case where the vehicles 200 are left in a monitoring service, the vehicle system makes the vehicles 200 stand by in a garage or the like.

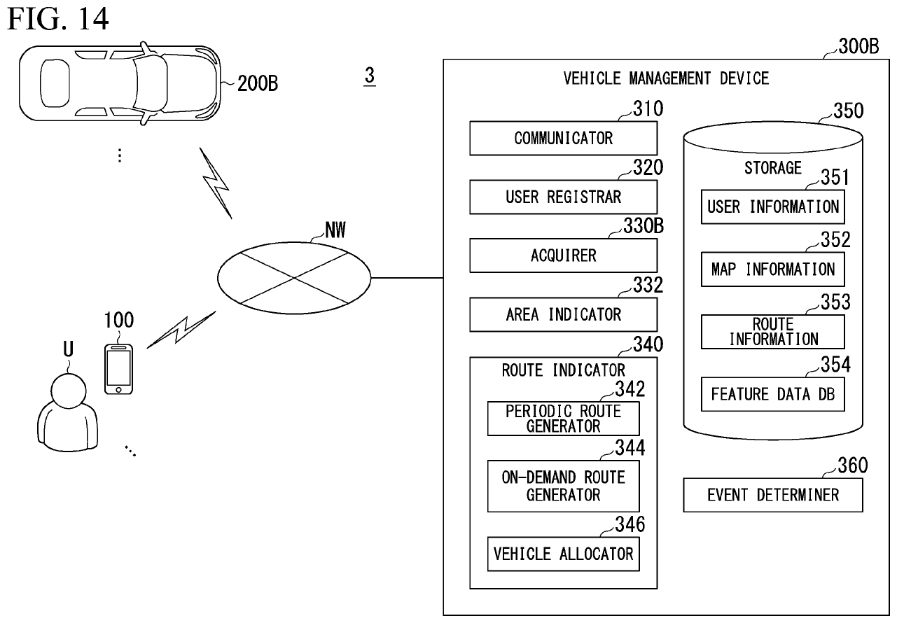

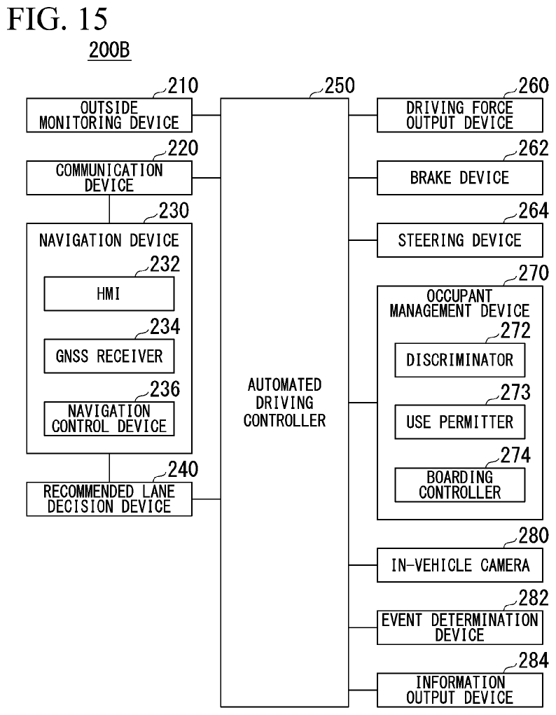

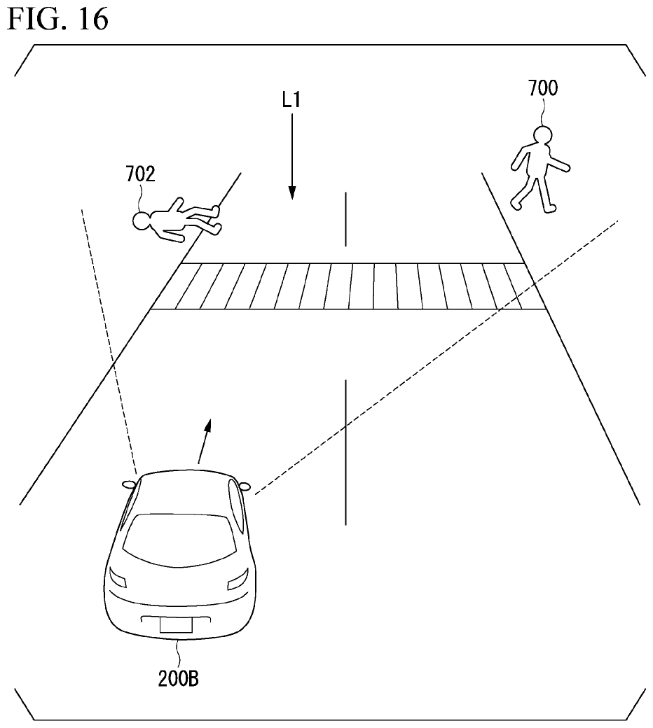

FIG. 14 is a configuration diagram of a vehicle system 3 of the third embodiment. In addition, FIG. 15 is a configuration diagram of a vehicle 200B of the third embodiment. In the vehicle system 3, a vehicle management device 300B includes an acquirer 330B and an event determiner 360. Further, in the vehicle system 3, the storage 350 includes an image data DB 354. Further, in the vehicle system 3, the vehicle 200B includes the in-vehicle camera 280, the event determination device 282, and the information output device 284. Functions of the other components are the same as those in the first embodiment. Therefore, hereinafter, in the vehicle system 3, a description will be mainly given with a focus on differences from the vehicle system 1 of the first embodiment. The event determiner 360 or the event determination device 282 is an example of an “event determiner”.

The in-vehicle camera 280 captures an image of the upper half of the body of an occupant who sits on the seat of the vehicle 200, centering on the occupant's face. The image captured by the in-vehicle camera 280 is output to the event determination device 282.

The event determination device 282 determines an event on the basis of an image captured by the in-vehicle camera 280 or an image captured by a camera of the outside monitoring device 210. The event includes, for example, an event in which a notification is required to be given to the outside with respect to a surrounding environment of the vehicle 200B or an in-vehicle situation. For example, the event includes an event indicating that there is a suspicious person or a lost child in the vicinity of the vehicle 200B, an abnormality occurs in a person inside or outside the vehicle, a serious incident such as close of a portion of a road occurs, damage to equipment or other criminal events occur, or the like. The occurrence of an abnormality in a person includes, for example, a case where it is determined that a person is falling down, crouching, or walking along with tottering due to illness, injury, or the like.

The event determination device 282 learns characteristics of a person who has an abnormality using machine learning such as deep learning on the basis of an image captured by the camera of the outside monitoring device 210, and estimates a person who has an abnormality from the captured image. In addition, the event determination device 282 may extract an edge portion of an object on the basis of an image captured by the camera of the outside monitoring device 210, may compare the shape of an area surrounded by the extracted edge portion with the shape of a person which is set in advance, and may estimate that the object is a person in a case where the degree of consistency between the shapes is equal to or more than a predetermined value (for example, equal to or more than 80%).

In addition, the event determination device 282 may perform image processing such as dimension conversion or compression based on pixel information read out from an image captured by the in-vehicle camera 280 or the camera of the outside monitoring device 210, and may generate feature data including a result of the image processing and attribute information of the image. The attribute information includes, for example, field angle information of the image, identification information of the camera capturing the image, date information when the image is captured, and position information of the vehicle 200B. In addition, the event determination device 282 collates the generated feature data with a pattern of feature data associated with an event determined in advance and determines an event having the highest degree of similarity to be an event for the vehicle 200B.

In addition, the event determination device 282 may transmit the feature data generated from the camera image to the vehicle management device 300B through the communication device 220 and may acquire event information determined by the event determiner 360 of the vehicle management device 300B. In this case, the acquirer 330B of the vehicle management device 300B acquires the feature data transmitted from the vehicle 200B. The event determiner 360 collates, for example, the feature data acquired by the acquirer 330B with the feature data DB 354 stored in the storage 350, acquires event information associated with feature data having the highest degree of similarity, and transmits the acquired event information to the vehicle 200B.

Here, the feature data DB 354 is a database which is learned beforehand by the event determiner 360. In the feature data DB 354, an event is associated with feature data. During the learning, first, the acquirer 330B causes the storage 350 to at least temporarily store feature data transmitted from a plurality of vehicles. In addition, the event determiner 360 performs a detailed event analysis process on the feature data stored in the storage 350 using machine learning, such as deep learning, a statistic process, or the like, generates the feature data DB 354 in which an event is associated with feature data, and causes the storage 350 to store the feature data DB.

FIG. 16 is a diagram showing a process of determining an event. In the example of FIG. 16, a status where it is determined that an abnormality occurs in a person estimated by an image is shown. For example, in a case where the vehicle 200B is traveling in a periodic route L1, the event determination device 282 analyzes an image captured by the camera of the outside monitoring device 210 to estimate a person in which an abnormality occurs from the captured image. In the example of FIG. 16, the event determination device 282 estimates that objects 700 and 702 are persons.

In addition, the event determination device 282 determines whether or not a person is in an abnormal state on the basis of the direction of the shape or operation of the person. For example, the event determination device 282 determines that the person is in a normal state in a case where the person is standing, and determines that the person is in an abnormal state in a case where the person is crouching or walking along with tottering. In the example of FIG. 16, the event determination device 282 determines that the object 700 is a person in a normal state and determines that the object 702 is in an abnormal state.

In a case where the event determination device 282 determines that the object 702 is a person in an abnormal state, the occupant management device 270 provides a predetermined notification service on the basis of a determined event and user information discriminated by the discriminator 272. For example, the occupant management device 270 controls the automated driving controller 250 so that the vehicle is stopped at the position of the person (object 702) as control determined in advance for the event. In addition, the information output device 284 outputs or displays a message for prompting the person to board the vehicle using a voice by a speaker provided outside the vehicle or a terminal provided on the surface of the vehicle. Further, in a case where there is no response of the person even after a predetermined time has elapsed from the output of the message, the information output device 284 transmits a predetermined notification to at least one of, for example, the vehicle management device 300B, the terminal device 100 set in advance, a manager terminal, a terminal in a predetermined institution such as a hospital, and a terminal in a municipal officer of a district through the communication device 220. Here, the predetermined notification is, for example, a notification of information including information indicating that there is a sick person, an injured person, or the like, the position of the person, and a captured image or video.

Further, in a case where the discriminator 272 determines that a person determined to be falling down is a person capable of using the vehicle 200B, the boarding controller 274 permits boarding of the vehicle 200B. Further, in a case where the person determined to be falling down boards the vehicle, the boarding controller 274 inquires a route for transporting the person to a nearby hospital where the person can be treated from the vehicle management device 300. The boarding controller 274 controls the automated driving controller 250 so that the vehicle travels on the basis of a route which is a search result received from the vehicle management device 300.

In addition, the event determination device 282 may determine the state of an occupant in the vehicle interior imaged by the in-vehicle camera 280. In a case where it is determined that the state of an occupant is abnormal, the information output device 284 sends a notification for confirming the occupant's state to the occupant using an in-vehicle speaker or a terminal provided within the vehicle. Specifically, the information output device 284 outputs a message for confirming the occupant's state to the occupant through a voice, or performs screen display on the HMI 232. In a case where it is determined that there is no response even after a message is output and then a predetermined time has elapsed, the event determination device 282 determines that abnormality occurs in the occupant. In a case where it is determined that abnormality occurs in the occupant, the information output device 284 transmits, for example, a predetermined notification to at least one of a notification destination or the terminal device 100 associated with the occupant's user information by the discriminator 272, the vehicle management device 300, a manager terminal, a terminal of a predetermined institution such as a hospital, and a terminal of a municipal officer in a district. The predetermined notification referred to here is, for example, a notification of information including information indicating transportation of a sick person, an injured person or the like and an image captured by the in-vehicle camera 280.

As described above, according to the third embodiment, in addition to the exhibition of the same effect as that in the first and second embodiments, it is possible to provide a service of monitoring people around a district using traveling in a state in which there is no occupant. Thereby, for example, it is possible to early find an emergency case or a person who suffered from an accident or the like, and to quickly contact a manager or transport him or her to a hospital. In addition, according to the third embodiment, it is possible to use the vehicle 200 during patrol based on a monitoring service as a shelter during an emergency. In addition, according to the third embodiment, an area in which a monitoring camera within an operation area is not installed is included in a patrol route for executing a monitoring service, and thus it is possible to monitor the entirety of the operation area. Meanwhile, the monitoring service of the third embodiment may be operated, for example, using subsidies of local governing bodies in districts in which circulation is performed, cooperation money from shopping centers in districts, or the like as a source of revenue.

### Fourth Embodiment

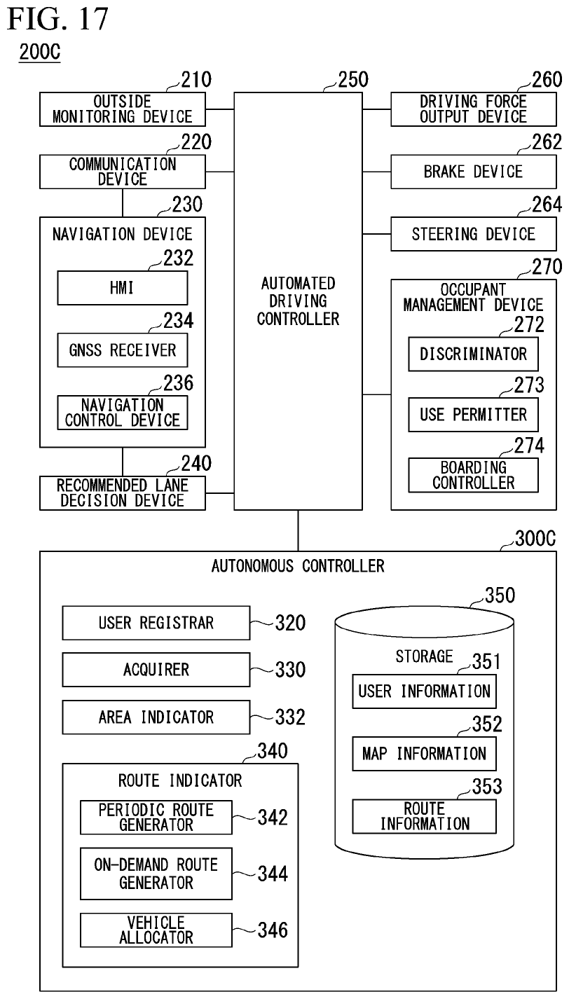

Some or all of the components of the vehicle management device 300 may be mounted in the vehicle 200. In the following description, an embodiment in which some of the components of the vehicle management device 300 are mounted in a vehicle as an autonomous controller is defined as a fourth embodiment. FIG. 17 is a configuration diagram of a vehicle 200C of the fourth embodiment. The vehicle 200C of the fourth embodiment is provided with, for example, an autonomous controller 300C as compared to the configuration of the vehicle 200 of the first embodiment. Therefore, hereinafter, a description will be mainly given with a focus on the function of the autonomous controller 300C.

The autonomous controller 300C includes, for example, a user registrar 320, an acquirer 330, an area indicator 332, a route indicator 340, and a storage 350. These components have the same functions as those of the components having the same names in the vehicle management device 300 of the first embodiment, and thus a specific description herein will not be given. Meanwhile, the user registrar 320 or the like may perform only registration for a user of a host vehicle, and the user information 351, the map information 352, and the route information 353 may be acquired by download from the vehicle management device 300.

The vehicle 200C communicates with the terminal device 100 of the user U using the communication device 220. In addition, the area indicator 332 of the autonomous controller 300C ascertains, for example, which user desires to board a vehicle in which time slot and in which district on the basis of a signal received from the terminal device 100, the user information 351 or the like, and specifies a district including a boarding point as an operation area on the basis of the ascertained information. In addition, the route indicator 340 of the autonomous controller 300C generates a prescribed route for traveling within the range of the operation area. In addition, the route indicator 340 generates an on-demand route on the basis of the use situation of the operation area included in a signal received by the communication device 220, and selects the generated on-demand route instead of the prescribed route. The automated driving controller 250 operates the selected route using autonomous driving.

As described above, according to the fourth embodiment, in addition to the exhibition of the same effect as that of the first to third embodiments, a portion of the function of the vehicle management device 300 is given to the vehicle 200C, and thus the vehicle 200C can autonomously perform the specification of an operation area, the selection of a route, or the like. In addition, according to the fourth embodiment, even in a case where an indication from the vehicle management device 300 is not accepted, the vehicle 200C can operate a more appropriate route on the basis of an indication from the terminal device 100. In each of the first to fourth embodiments, some or all of other embodiments may be combined.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

In addition, in a case where the vehicle 200 is a manual driving vehicle, the communicator 310 may communicate with a terminal device of a driver of the vehicle 200 through the network NW. In addition, the above-described vehicle systems 1 to 3 can be used in, for example, a ride-sharing providing service in which one or more vehicles are used together by a plurality of users.

What is claim is:

1. A vehicle system comprising:
an area indicator that specifies an operation area of an autonomous vehicle;
a discriminator that discriminates a user with respect to the autonomous vehicle;
a use permitter that allows a user discriminated to be a user who is able to use the autonomous vehicle by the discriminator to occupy and use at least a portion of the autonomous vehicle;
a communicator that communicates with a user's terminal device; and
a route indicator that indicates a route to the autonomous vehicle on the basis of one or both of a prescribed route for circulating inside the operation area along a route determined in advance and an on-demand route based on information received by the communicator,
wherein the route indicator compares a degree of priority of the prescribed route with a degree of priority of the on-demand route, and indicates either route to the autonomous vehicle.

2. The vehicle system according to claim 1, wherein the area indicator indicates routes varying according to time slots to the autonomous vehicle within the operation area.

3. (canceled)

4. (canceled)

5. The vehicle system according to claim 1, wherein the route indicator allocates a traveling period for the on-demand route on the basis of a use situation of the autonomous vehicle corresponding to the prescribed route.

6. The vehicle system according to claim 1, wherein an in-vehicle communicator that communicates with a user's terminal device and transmits information indicating whether the autonomous vehicle is available is mounted in the autonomous vehicle.

7. The vehicle system according to claim 1, further comprising a vehicle allocator that allocates a plurality of the autonomous vehicles in order to circulate inside the operation area.

8. The vehicle system according to claim 1, wherein the autonomous vehicle further includes:
an imaging unit that captures an inside or outside image of the vehicle;
an in-vehicle communicator that transmits feature data of an image captured by the imaging unit to a server device;
an event determiner that determines an event on the basis of feature data which is at least temporarily stored in the server device; and
a provider that provides a notification on the basis of event information determined by the event determiner and user information discriminated by the discriminator.

9. An autonomous vehicle comprising:
an in-vehicle communicator;
an area indicator that specifies an operation area using a signal received in the in-vehicle communicator; and
an autonomous controller that generates a prescribed route for circulating within a range of the operation area,
wherein the autonomous controller selects an on-demand route instead of the prescribed route on the basis of a use situation of the operation area received by the in-vehicle communicator.

10. A vehicle control method comprising causing a computer to:
indicate a route to an autonomous vehicle within an operation area;
discriminate a user who is able to use the autonomous vehicle;
allow a user discriminated to be a user who is able to use the autonomous vehicle to occupy and use at least a portion of the autonomous vehicle;
control the number of autonomous vehicles within the operation area on the basis of an occupation and use state of the at least a portion;
communicate with a user's terminal device;
indicate a route to the autonomous vehicle on the basis of one or both of a prescribed route for circulating inside the operation area along a route determined in advance and an on-demand route based on information received; and
compare a degree of priority of the prescribed route with a degree of priority of the on-demand route, and indicates either route to the autonomous vehicle.

11. A non-transitory computer-readable storage medium that stores a program to be executed by a computer to perform at least:
specify an autonomous vehicle within an operation area;
indicate a route to the specified autonomous vehicle;
discriminate a user who is able to use the autonomous vehicle;
allow a user discriminated to be a user who is able to use the autonomous vehicle to start to occupy and use at least a portion of the autonomous vehicle;
continuously monitor an occupation and use state of the at least a portion, and control the number of autonomous vehicles within the operation area on the basis of the occupation and use state;
communicate with a user's terminal device;
indicate a route to the autonomous vehicle on the basis of one or both of a prescribed route for circulating inside the operation area along a route determined in advance and an on-demand route based on information received; and
compare a degree of priority of the prescribed route with a degree of priority of the on-demand route, and indicates either route to the autonomous vehicle.
